(19) United States
(12) Patent Application Publication
(10) Pub. No.: US 2021/0064527 A1
(43) Pub. Date: Mar. 4, 2021

(54) COMPUTER ARCHITECTURE WITH UNIFIED CACHE AND MAIN MEMORY AND ASSOCIATED METHODS

(71) Applicant: CloudMinds Technology, Inc., Santa Clara, CA (US)

(72) Inventors: William Xiao-qing HUANG, Santa Clara, CA (US); Qiang LI, Santa Clara, CA (US)

(73) Assignee: CloudMinds Technology, Inc., Santa Clara, CA (US)

(21) Appl. No.: 17/009,770

(22) Filed: Sep. 1, 2020

Related U.S. Application Data
(60) Provisional application No. 62/894,900, filed on Sep. 2, 2019.

(51) Int. Cl. G06F 12/0802

(52) U.S. Cl. CPC G06F 12/0802; G06F 2212/7201

(57) ABSTRACT

A computer system can unify main memory and cache memory, wherein fully associative mapping method can be utilized to cover a whole range of cache and main memory. In the system, central processing unit (CPU) sends a data request and access the cache portion of the unified cache and memory system; fully associative search is conducted on the unified cache and main memory system as one range of physical memory; if matching data is found on the cache portion, the data is returned to the CPU; if matching data is found on the main memory portion, the matching data is swapped to the cache portion and then return the data to the CPU; if matching data is not found in either portion of the unified cache and main memory system, the operating system is trigged to handle the page fault.

### CROSS-REFERENCE TO RELATED APPLICATION

The present application claims priority to U.S. Provisional Patent Application No. 62/894,900 filed on Sep. 2, 2019, the disclosure of which is hereby incorporated by reference in its entirety.

### BACKGROUND

A typical modern computer system can employ a virtual memory system. Virtual memory is a memory management technique that is implemented using both hardware (MMU) and software (operating system).

### SUMMARY

The present disclosure relates generally to computer systems, and particularly to a memory system and methods utilizing cache and main memory.

In an aspect, a memory system having a unified cache and main memory and various associated memory management methods which can be implemented utilizing a computer system are provided. The memory system can include: one or more than one cache memory provided proximal the central processing unit being operatively connected to the central processing unit; a main memory; and a plurality of sets of computer executable instructions stored on the secondary storage, which can be loaded into the memory for execution when needed. Wherein,

at least one set of computer executable instructions contains instructions for the system to perform the following tasks: recognize repeated access to one or more pages contained on the main memory;

recognize repeated access to the one or more pages; determine a hierarchy with regard to various accessed pages contained on the cache memory; and swap one or more pages on the cache memory between the cache memory and the main memory based on the determined hierarchy.

In some embodiments, a single cache is provided and the cache is unified with the main memory, the unified main memory and cache can be connected to the central processing unit utilizing a system bus, wherein the cache portion can be located between the central processing unit and the main memory portion. Alternatively, the cache portion can also be provided integrally with the central processing unit.

In some embodiments, storage size of the cache portion of the unified main memory and cache can be as big as the main memory.

In some embodiments, multiple caches are provided, one or more than one of the caches are unified with the main memory, wherein, the unified main memory and cache can be connected to the central processing unit utilizing a system bus, wherein the cache portion can be located between the central processing unit and the main memory portion. The caches that are not unified with the main memory can be provided integrally with the central processing unit.

In some embodiments, central processing unit can be instructed to delete redundant copies of information upon completion of a swap procedure.

In some embodiments the determined hierarchy can be based at least in part on relative frequency of use.

In some embodiments, the central processing unit can be instructed to organize information on the cache and main memory in a manner consistent with fully associative methods.

In another aspect, a computer system is provided, including:

a central processing unit;

a cache memory provided proximal the processing unit being operatively connected to the central processing unit;

a main memory; and

a plurality of sets of computer executable instructions stored in disk and can be loaded into the memory, wherein at least one set of computer executable instructions contain instructions for the system to perform the following tasks:

recognize repeated access to one or more pages contained on the main memory;

recognize repeated access to the one or more pages;

determine a hierarchy with regard to various accessed pages contained on the cache memory; and

swap one or more pages on the cache memory between the cache memory and the main memory based on the determined hierarchy.

In some embodiments, the unified main memory and cache is connected to the central processing unit utilizing a system bus.

In some embodiments, the cache portion of the unified main memory and cache is located between the central processing unit and the main memory portion of the unified main memory.

In some embodiments, the cache memory portion of the unified main memory and cache is provided integrally with the central processing unit.

In some embodiments, a storage size of the cache memory is greater than 10% of a storage size of the main memory.

In some embodiments, multiple caches of varies sizes are provided, wherein, some caches are provided integrally with the central processing unit, some caches are provided further away from the central processing unit and unified with the main memory.

In some embodiments, the one or more sets of computer instructions are configured to instruct the central processing unit to delete redundant copies of information upon completion of a swap procedure.

In some embodiments, the hierarchy is based at least in part on relative frequency of use.

In some embodiments, the one or more sets of computer instructions include instructions for the central processing unit to organize information on the cache and main memory in a manner consistent with fully associative methods.

In another aspect, a computing method is provided, including:

providing a central processing unit;

providing a cache memory provided proximal the processing unit being operatively connected to the central processing unit;

providing a main memory; and

providing a plurality of sets of computer executable instructions stored in the cache memory or on the main memory, wherein at least one set of computer executable instructions contains instructions utilizing the central processing unit to perform the following steps:
recognizing repeated access to one or more pages contained on the main memory;
recognizing repeated access to the one or more pages;
determining a hierarchy with regard to various accessed pages contained on the cache memory; and
swapping one or more pages on the cache memory between the cache memory and the main memory based on the determined hierarchy.

In some embodiments, the method further includes connecting the main memory to the central processing unit utilizing a system bus.

In some embodiments, the cache memory portion of the unified main memory and cache is located between the central processing unit and the main memory portion of the unified main memory and cache.

In some embodiments, the cache memory portion of the unified cache and main memory is provided integrally with the central processing unit.

In some embodiments, a storage size of the cache memory is greater than 10% of a storage size of the main memory.

In some embodiments, the one or more sets of computer instructions are configured to instruct the central processing unit to delete redundant copies of information upon completion of the swapping step. Wrong and repetitive

In some embodiments, multiple caches of varies sizes are provided, wherein, some caches are provided integrally with the central processing unit, some caches are provided further away from the central processing unit and unified with the main memory.

In some embodiments, the hierarchy is based at least in part on relative frequency of use.

In some embodiments, the one or more sets of computer instructions include instructions for the central processing unit to organize information on the cache and main memory in a manner consistent with fully associative methods.

In another aspect, a computing method is provided, including:
providing a central processing unit;
providing a cache memory provided proximal the processing unit being operatively connected to the central processing unit;
providing a main memory, wherein the main memory is connected to the central processing unit utilizing a system bus; and
providing a plurality of sets of computer executable instructions stored in the cache memory or on the main memory, wherein at least one set of computer executable instructions contains instructions utilizing the central processing unit to perform the following steps:
   recognizing repeated access to one or more pages contained on the main memory;
   recognizing repeated access to the one or more pages;
   determining a hierarchy with regard to various accessed pages contained on the cache memory, wherein the hierarchy is based at least in part on relative frequency of use;
   swapping one or more pages on the cache memory between the cache memory and the main memory based on the determined hierarchy; and
   deleting redundant copies of information upon completion of the swapping step;
   organizing information stored on the cache and main memory in a manner consistent with fully associative methods;

wherein the cache memory is located between the central processing unit and the system bus

In some embodiments, a storage size of the cache memory is greater than 10% of a storage size of the main memory.

It should be understood that both the foregoing general description and the following detailed description are exemplary and explanatory only and are not restrictive of the disclosure. Other aspects and embodiments of the present disclosure will become clear to those of ordinary skill in the art in view of the following description and the attached drawings.

### BRIEF DESCRIPTION OF THE DRAWINGS

To more clearly illustrate some of the embodiments, the following is a brief description of the drawings.

The drawings in the following descriptions are only illustrative of some embodiments. For those of ordinary skill in the art, other drawings of other embodiments can become apparent based on these drawings.

FIG. 1A illustrates an exemplary schematic of memory hierarchy in a computer system;

FIG. 1B illustrates an exemplary schematic of a computer system;

FIG. 1C illustrates the data structure of a page table entry of a computer system;

FIG. 1D illustrates the array of a fully associative cache with eight blocks in a computer system;

FIG. 2 illustrates an exemplary schematic of a computer system having a cache memory with increased size relative to the main memory;

FIG. 3 illustrates another exemplary schematic of a computer system having a cache memory which has been effectively unified with the main memory by covering both the cache memory and the main memory covered by one fully associative search;

FIG. 4 illustrates a mechanism in which that a small pool of available page frames is maintained in a cache portion of the unified cache and main memory system;

FIG. 5 illustrates a method in which fully associative search is conducted over the unified cache and main memory system and data swapped between the cache portion and main memory portion of the unified cache and main memory system.

FIG. 6 illustrate an exemplary schematic of a computer system having a unified cache and main memory system, wherein the cache portion of unified cache and main memory system can be placed close to the central process unit;

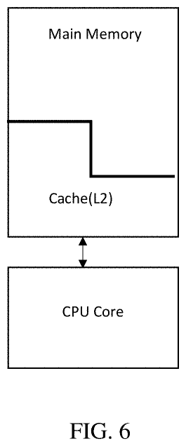

FIG. 7 illustrates an exemplary schematic of a computer system having more than one cache memory, wherein one of the cache memories can be effectively unified with a main memory and one or more than more than one cache can be placed close to the central processing unit; and

FIG. 8 illustrates another exemplary schematic of a computer system having more than one cache memory, wherein one of the cache memories can be effectively unified with a main memory and one or more than one cache can be provided integrally with the CPU.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. can be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or other structure is referred to as being “on” or extending “onto” another element, it can be directly on or extend directly onto the other element or intervening elements can also be present. In contrast, when an element is referred to as being “directly on” or extending “directly onto” another element, there are no intervening elements present.

Likewise, it will be understood that when an element such as a layer, region, or substrate is referred to as being “over” or extending “over” another element, it can be directly over or extend directly over the other element or intervening elements can also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

Relative terms such as “below” or “above” or “upper” or “lower” or “vertical” or “horizontal” can be used herein to describe a relationship of one element, layer, or region to another element, layer, or region as illustrated in the drawings. It will be understood that these terms and those discussed above are intended to encompass different orientations of the device in addition to the orientation depicted in the drawings.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The memory is an essential component in any digital computer since it is needed for storing program and data. In modern computer system, the total memory capacity of a computer can be visualized as being a “hierarchy of components.”

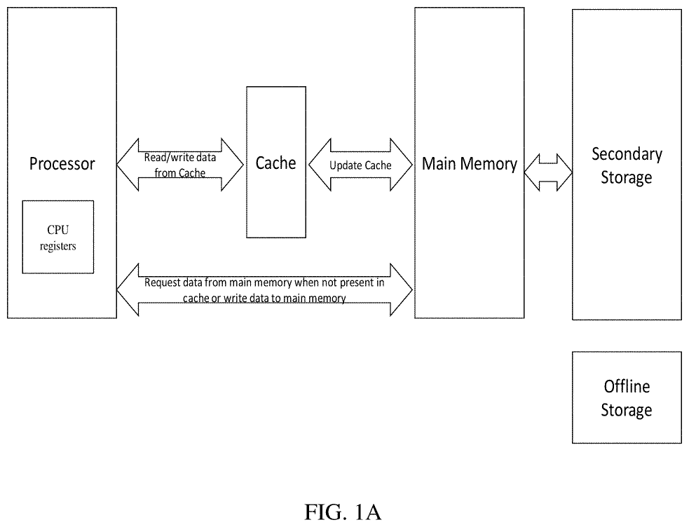

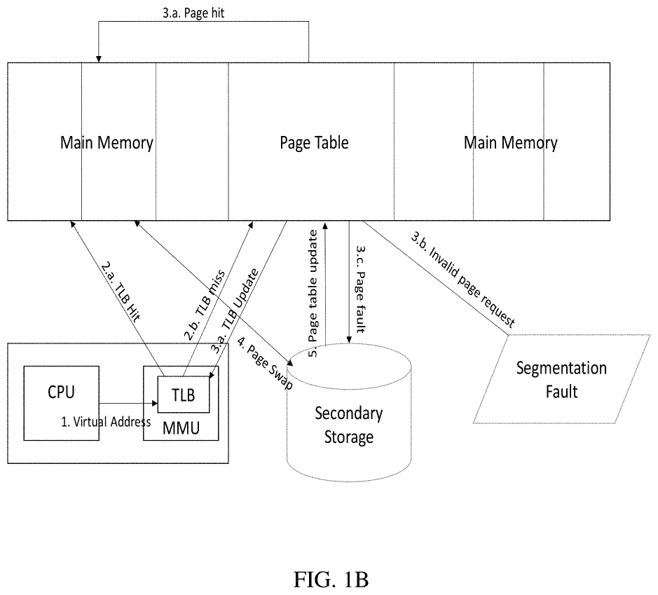

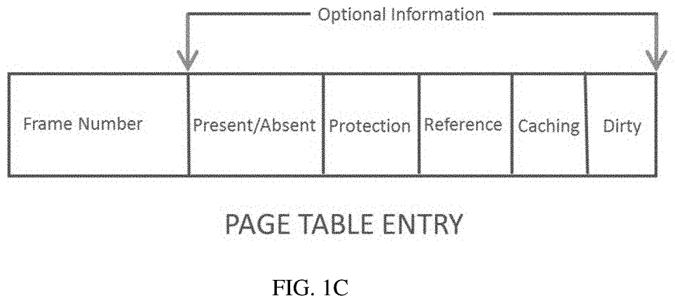

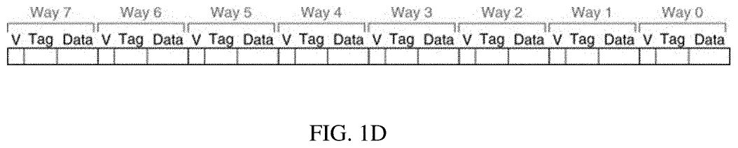

As illustrated in FIG. 1A, in a typical computer system, there are four major storage levels: Internal—processor registers and cache; main—the system RAM and controller cards; on-line mass storage—Secondary storage (such as hard disk); off-line bulk storage—Tertiary and Off-line storage (removable storage, such as CD-RW, USB thumb drive, tape drive).

“Auxiliary memory” (secondary storage and off-line storage) is slow but its capacity is high, “Main memory” to is smaller but faster than auxiliary memory, “Cache memory” is even smaller and faster than main memory and is accessible to the highspeed processing logic and registers in CPU.

In a typical modern computer system, auxiliary memory access time is generally 1000 times that of the main memory. The main memory occupies the central position because it is equipped to communicate directly with the CPU and Cache and communicate with auxiliary memory devices through Input/output processor (I/O). When the program not residing in main memory is needed by the CPU, they are brought in from auxiliary memory. Programs and data not currently needed in main memory are transferred into auxiliary memory to provide space in main memory for other programs that are currently in use. The cache memory is used to store programs and data so that future requests for that data can be served faster, data stored in cache might be the result of an earlier computation or a copy of data stored elsewhere. Approximate access time ratio between cache memory and main memory is about 1 to 7-10.

Cache memory is typically a special very high-speed SRAM memory typically on or close to the system's central processing unit (CPU), Cache memory is used to reduce the average time to access data from the Main memory. Traditionally, the cache is typically smaller and faster memory which has historically been utilized to store copies of the data from frequently used main memory locations. In Modern system, multi-level cached can be implemented, wherein, some caches may be built on CPU die, some other caches may be built off the CPU die.

The system may also include cache and memory management circuits, such as memory management unit (MMU), Memory microcontroller (MCU) and Memory Protection Unit (MPU), which can be located on the same board as the CPU, they may also be provided in separate integrated chip (IC). The MMU primarily perform the translation of virtual address to physical address, The MCU is a digital circuit that manages the flow of data going to and from the computer's main memory.

A typical modern computer system can employ a virtual memory system. Virtual memory is a memory management technique that is implemented using both hardware (MMU) and software (operating system).

Compared with a real memory device available on a system, the virtual memory can employ a concept of virtual address space, which allows each process considering physical memory as a contiguous address space (or collection of contiguous segments). A goal of virtual memory is to map virtual memory addresses generated by an executing program into physical addresses in computer memory. This often concerns two main aspects: address translation (from virtual to physical) and virtual address space management.

The address translation can be implemented on or off a central processing unit (CPU) chip by a specific hardware element referred to as Memory Management Unit (MMU). The virtual address space management can be provided by the operating system, which sets up virtual address spaces (i.e., either a single virtual space for all processes or one for each process) and actually assigns real memory to virtual memory.

Furthermore, software within the operating system may provide a virtual address space that can exceed the actual capacity of main memory (i.e., using also secondary memory), and thus reference more memory than is physically present in the system.

Paging systems can be employed in a computer system utilizing virtual memory system. Paging is a memory management scheme that eliminates the need for contiguous allocation of physical memory. This scheme permits the physical address space of a process to be non-contiguous.

In paging systems, the main physical memory is organized into a sequence of fixed sized “page frames,” and program executable code and data are organized into “pages” of the same size of page frames. When a program is running, some of its pages are loaded into page frames in the main memory. Not all of a program's pages need to be in the main memory. When a page is needed, but not in memory, it is said a “page fault” has occurred, and the page will be brought into the main memory from the secondary storage.

In order to translate virtual addresses of a process into physical memory addresses used by the hardware to actually process instructions, the MMU can make use of so-called page table, e.g., a data structure managed by the OS that store mappings between virtual and physical addresses. Concretely, the MMU stores a cache of recently used mappings out of those stored in the whole OS page table, which can be referred to as Translation Lookaside Buffer (TLB).

As illustrated in FIG. 1B, when a virtual address needs to be translated into a physical address, the MMU first searches for it in the TLB cache (step 1). If a match is found (i.e., TLB hit) then the physical address is returned and the computation simply goes on (2.a.). Conversely, if there is no match for the virtual address in the TLB cache (i.e., TLB miss), the MMU searches for a match on the whole page table, i.e., page walk (2.b.). If this match exists on the page table, this is accordingly written to the TLB cache (3.a.). Thus, the address translation is restarted so that the MMU is able find a match on the updated TLB (1 & 2.a.).

Page table lookup may fail due to various reasons, often in two cases. For example, the first one is when there is no valid translation for the specified virtual address (e.g., when the process tries to access an area of memory which it cannot ask for). Otherwise, it may happen if the requested page is not loaded in main memory at the moment (an opposite flag on the corresponding page table entry indicates this situation).

In both cases, the control passes from the MMU (hardware) to the page supervisor (a software component of the operating system kernel). In the first case, the page supervisor typically raises a segmentation fault exception (3.b.).

In the second case, instead, a page fault occurs (3.c.), which means the requested page has to be retrieved from the secondary storage (i.e., disk) where it is currently stored. Thus, the page supervisor accesses the disk, re-stores in main memory the page corresponding to the virtual address that originated the page fault (4.), updates the page table and the TLB with a new mapping between the virtual address and the physical address where the page has been stored (3.a.), and finally tells the MMU to start again the request so that a TLB hit will take place (1 & 2.a.).

As it turns out, the task of above works until there is enough room in main memory to store pages back from disk. However, when all the physical memory is exhausted, the page supervisor must also free a page in main memory to allow the incoming page from disk to be stored.

To fairly determine which page to move from main memory to disk, the paging supervisor may use several page replacement algorithms, such as Least Recently Used (LRU). Generally speaking, moving pages from/to secondary storage to/from main memory is referred to as swapping (4.)

In a paging system, when the system accesses a memory location, it first looks at the cache memory to see if the needed data is there. If it is, the access is completed at a high speed. If not, called as a “cache miss,” the main memory will be accessed, which is typically many times slower than cache memory. Furthermore, if the needed data is not in the main memory, referred to as a “page fault,” the data will be brought into the main memory from the secondary storage, which will result in retrieval speeds hundreds or thousands of times slower than accessing cache.

Similar to the main memory, cache memory is organized into fixed-sized “cache lines.” When the system needs to access a memory location, the address of the location is used to search in cache to see if there is a match or not. Cache mapping is the method by which the contents of main memory are brought into the cache and referenced by the CPU. The mapping method used directly affects the performance of the entire computer system. There are different ways of organizing the search. For Example, Direct Mapping, Fully Associative Mapping or Set Associative Mapping.

Pre-existing systems typically utilize a placement policy decides where in the cache a copy of a particular entry of main memory will go. If the placement policy is free to choose any entry in the cache to hold the copy, the cache is then referred to as fully associative. At the other extreme, if each entry in main memory can go in just one place in the cache, the cache is directly mapped. Many caches implement a compromise in which each entry in main memory can go to any one of N places in the cache and are described as N-way set associative.

In a fully associative cache, the cache is organized into a single cache set with multiple cache lines. A memory block can occupy any of the cache lines. The cache organization can be framed as (1*m) row matrix. FIG. 1C shows the array of a fully associative cache with eight blocks. Upon a data request, eight tag comparisons (not shown) must be made, because the data could be in any block.

To place a block in the cache: the cache line is selected based on the valid bit associated with it. If the valid bit is 0, the new memory block can be placed in the cache line, else it has to be placed in another cache line with valid bit 0. If the cache is completely occupied, then a block is evicted and the memory block is placed in that cache line. The eviction of memory block from the cache is decided by the replacement policy.

To search a word in the cache: the tag field of the memory address is compared with tag bits associated with all the cache lines. If it matches, the block is present in the cache and is a cache hit. If it doesn't match, then it's a cache miss and has to be fetched from the lower memory, i.e. the main memory. Based on the Offset, a byte is selected and returned to the processor.

Advantages of a fully associative cache structure provides the system with the flexibility of placing a particular memory block in any of the cache lines and hence full utilization of the cache. Which full utilization of the cache and the associated placement policy provides better cache hit rate.

Compared with direct mapping and set associative mapping, disadvantage of a fully associative cache search structure is that the placement of data in the cache is slower as it takes time to iterate through all the lines wherein the placement policy causes the system to require large amounts of power as the system often needs to iterate over the entire cache set to locate a block. However, in the present disclosure, high efficiency fully associative search methods available that can be utilized to conduct fast fully associative search in the present disclosure, for example . . . .

The present disclosure provides a system which utilizes a fully associative search method wherein the fully associative search and placement methods are utilized on a unified memory system having both cache and main memory portions. For example, any data can be put into any cache line or page frame on either the cache or main memory portions, which will be advantageous over the other methods, as will be appreciated by those having skill in the art utilizing the methods discussed herein.

The size of cache memory can be an important factor affecting cache miss rate, while the size of the main memory can be an important factor for page fault rate. Due to accessing secondary memory and bring data from secondary memory to main memory is so much slower than accessing data that already in the main memory, there is a heavy performance penalty of page fault, page fault rate needs to be minimized by all means.

In general, a system can be configured to have enough main memory, so the page fault rate is kept very low, such as 0.001%, for targeted workloads, the page fault rate (In a given time, Page fault rate=number of page fault/number of page hit+number of page fault) can be further reduced utilizing unified cache and main memory system utilizing fully associative mapping method disclosed by the present disclosure.

In the traditional architecture, cache memory does not contribute to the total size of physical memory when it comes to page fault rate. This is because the data in the main memory is copied to cache memory and the original data remains in the main memory, as such cache memory merely contains duplicates of data which is also stored at various main memory locations at the time. For example, the cache contains data required for programs that are used frequently for faster access so as to increase system speed by reducing the frequency main memory must be accessed. In this case, the cache memory size can be much smaller than the main memory size, which smaller memory is not an issue for function, as any needed information, if overwritten can be accessed from the main memory at a different time.

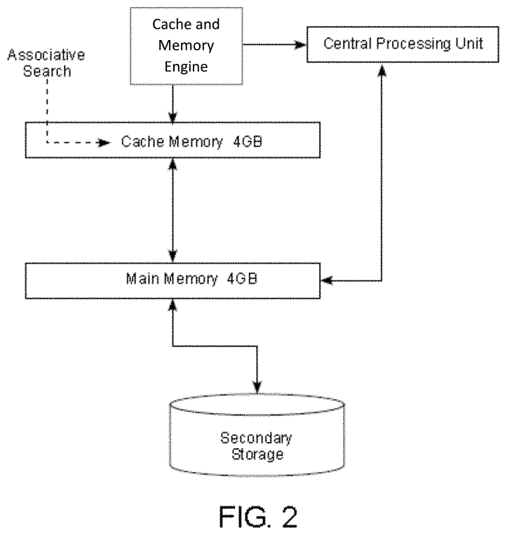

However, with the advance of semiconductor technology, larger cache memory becomes available, reaching Gigabytes in size, which is comparable to the main memory size. In addition, fully associative search for large cache memory becomes possible. For example, as illustrated in FIG. 2. technology has advanced to the point where cache memory capacity is substantially increased as chip and other fabrication technologies have advance.

In a conventional computer system, even though in some cases, the cache memory is large, for example, the cache memory size becomes near in size, or even equal to, the size of the main memory, the total memory capacity is wasted in regard to reducing page fault rate. For example, as illustrated in FIG. 2, the total memory size, cache and the main memory, is 8 GB i.e. 4 GB main memory plus 4 GB of cache memory, the physical memory size in regard to page fault rate is still 4 GB. In a way, nearly half of the total memory capacity is wasted in regard to reducing page fault rate in situations where the cache is near in size to the main memory.

In some instances, such as when cache size becomes large, a corresponding cache line can also become large. In the following, it can then be assumed that the cache line size is the same as the page size, and thus the term “page” can be utilized for both page and cache line. However, in implementation they can still be different sizes.

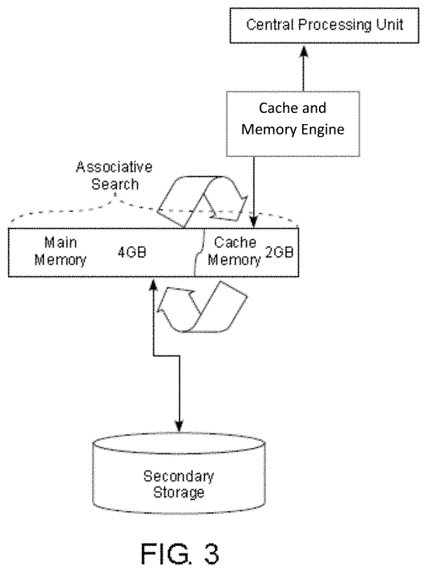

Some embodiments of the present disclosure can include such a system wherein the cache memory is comparable to the size of the main memory. For example, where the cache memory can be 50% or larger in size as compared to the main memory. In such a case, and as illustrated in FIG. 3, as one aspect of the present disclosure, the cache memory can be unified with the main memory. This unification of the cache memory and main memory can then allow for instances in which any data in the unified cache and main memory system is unique. In other words, data that is in the cache portion is not in the main memory portion at any given time, and vice versa, which is different from the traditional system in which the cache and main memory are separated from each other, in the traditional system, when a caching occurs, data in the main memory is copied to the cache, the original data before the copying remains in the main memory.

As illustrated in FIG. 3, the information in the unified cache and memory system is unique and fully associative mapping method can be utilized to cover the whole range of cache and main memory, in the system, CPU sends a data request and access the cache portion of the unified cache and memory system; fully associative search is conducted on the unified cache and main memory system as one range of physical memory; if matching data is found on the cache portion, the data is returned to the CPU; if matching data is found on the main memory portion, the matching data is swapped to the cache portion and then return the data to the CPU; if matching data is not found in either the cache portion or the main memory portion of the unified cache and main memory system, the operating system is trigged to handle the page fault.

In other words, the memory pages or cache lines which contain frequently accessed information can be retained on the cache instead of in main memory, wherein when information which is transferred to the cache is then replaced in the main memory with what the information is replacing on the cache. In the system contemplated herein, this exchange is a swap of information between the main memory and the cache, not a copy of redundant information. As such, the information which has become pre-emptied on the cache and is to be replaced with another higher priority item is not merely overwritten, but instead moved from cache to the main memory and a new address location is assigned on the main memory

On the basis of unique information in the unified cache and main memory system, in some aspects of the present disclosure, there are two differences as compared to the traditional systems discussed above:

The associative cache search method can then be utilized to cover both cache and the main memory as one range of physical memory. As opposed to the traditional systems, where a page in cache always has a copy in the main memory and the fully associative cache search only covers the relatively small cache portion of the memory and cannot cover both cache and main memory In contrast, in the system according to some embodiments of the present disclosure a page can be either in the cache portion or in the main memory portion of the unified cache and main memory and cannot be in both.

According to some embodiments of the present disclosure, fully associative search through the whole range of the unified cache and main memory system can be implemented through a hardware approach or other high efficiency fully associative search methods. In the hardware approach, since using sequential search that search through all tags to find an entry in a fully associative memory would be too slow, the search can be done in parallel. A comparator for each memory entry can be provided to check an address against all the addresses currently in the memory, plus a selector to access the correct contents. If the address is found, the associated contents is returned.

Based on above, the following methods can be provided to be utilized in the unified cache and memory system to manage data access.

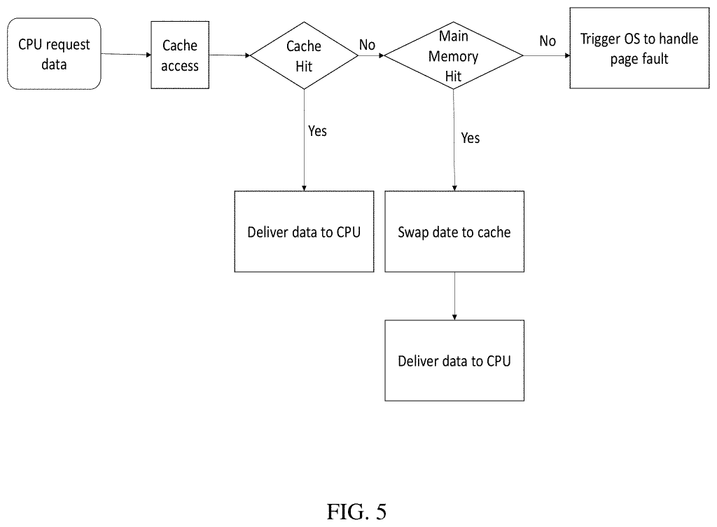

As illustrated in FIG. 5, the method includes the following steps:

Step 1: the central processing unit issues a virtual memory access request and access the cache portion of the unified cache and memory system;

if matching virtual address is found in the cache portion of the unified cache and memory system utilizing fully associative search method, then in Step 2 the matching data found is delivered to the CPU from the cache portion;

if matching data is not found in the cache portion but found in the main memory portion of the unified cache and memory system utilizing fully associative search method, then in Step 3 the matching data is first swapped to the cache portion, then the matching data is delivered to the CPU from the cache portion;

if a match is neither found in cache portion or main memory portion of the unified cache and memory system, i.e., a page fault occurs, then in Step 4 the operating system is triggered to handle the page fault, i.e., the operating system brings the matching data from secondary storage to the main memory and cache, and then the data is delivered to the CPU.

With the sample sizes as illustrated in FIG. 3, the illustrated system is provided 6 GBs of physical memory regarding to page fault rate, as a result, page fault rate is significantly reduced compared with the traditional system where there is only 4 GB of memory regarding to page fault rate.

According to some embodiments of the present disclosure, the mechanism of bringing a page from the main memory portion into cache portion of the unified cache and main memory system is the same as the traditional system with split cache and main memory in which a fully associative mapping method is utilized to place a page from main memory to cache memory, however, the present disclosure is different from the traditional system in in one aspect: in a traditional system, the pages in cache except dirty pages (changed pages) are not written back to main memory, when the cache is full and available space are needed in the cache for caching other pages, the selected old pages are evicted (or overwritten) according to cache replacement policy such as least recently used method, in contrast, in the present disclosure, any preempted page in cache must be swapped to the main memory, regardless of whether the page is dirty, i.e. the page contains changed data, or not.

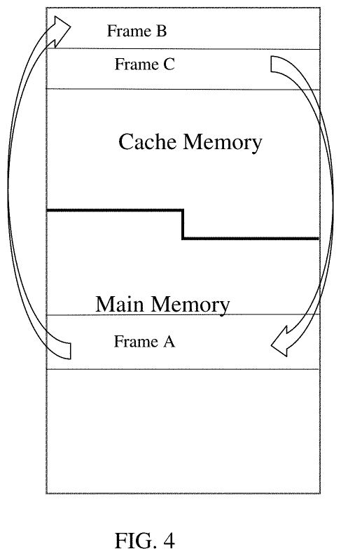

As illustrated in FIG. 4, An additional mechanism according to some embodiments of the present disclosure is that a small pool of available page frames can be maintained in cache so when a page frame is needed, it will have a high probability to be available. When the pool size falls below a threshold, some pages will be moved to main memory and the page frames are added to the pool.

As illustrated in FIG. 4, the mechanism includes the following steps:

Step 1: CPU issues a request for memory access to page X;

if the engine determines that page X is in page frame A of the main memory and if there is at least one page frame B available in the pool in the cache memory, then in step 2, the engine copies page X into page frame B in the pool in the cache memory and CPU can then start to use page X; if the engine determines that page X is in page frame A of the main memory and if there is no page frame available in the pool in the cache memory, then the engine waits until a frame is available in the pool in the cache memory, and then step 2 is executed, in which the engine copies page X into a page frame B in the pool in the cache memory and CPU can then start to use page X;

Step 3: the engine continues to identify a page Y and if it determines page Y is in frame C of cache memory, page Y is then put into a copy list with target location as frame A of the main memory.

Step 4: the engine copies page Y into page frame A of the main memory.

Step 5: page frame C of the cache memory becomes empty and is added to the pool.

The replacement algorithms used for the above mechanism can be any of the existing ones such as a “random replacement,” “least recently used” algorithm, “first in first out” algorithm, “last in first out” algorithm, “most recently used” algorithm, “lease frequently used” algorithm and “least frequent recently used” or others as will be appreciated by those having skill in the art. With a small memory, the least recently used block might be replaced; that's the block that has been unreferenced for the longest time. However, the circuitry to keep track of when a block was used is complicated, with a larger memory, the block to replace might be chosen at random, since random choice is much easier to implement in hardware.

Advantageously, according to some embodiments of the present disclosure, when the cache memory becomes large enough to be comparable with the main memory, it can be utilized to contribute to the total size of the main memory in regard to page fault rate, as a result, saving main memory and power consumption, especially for relatively small systems, such as mobile phones, notebook computers, intelligent robot controllers, etc., in which the main memory size is relatively small compared with large systems.

In addition, according to some embodiments of the present disclosure, some of the mechanism and hardware support for virtual address and physical address translation becomes unnecessary, such as page table and the Translation Look-aside Buffer (TLB).

In traditional virtual memory system, in order to translate virtual addresses of a process into physical memory addresses used by the hardware to actually process instructions, the MMU makes use of so-called page table, i.e., a data structure managed by the operating system that store mappings between virtual and physical addresses.

A page table contains one “page table entry” (PTE) per page. As illustrated in FIG. 1B, a PTE includes a frame number, optionally, it may also include information about whether the page has been written to (the “dirty bit” or “modified bit”), whether a particular page you are looking for is present or absent (“present/absent bit”; if it is not present, it is called a page fault), when it was last used (the “reference bit,” for a least recently used (LRU) page replacement algorithm), what kind of processes (user mode or supervisor mode) may read and write it (“protection bit”), and whether it should be cached (“caching bit”). The physical page number is combined with the page offset to give the complete physical address.

In the present disclosure, since the cache and main memory is unified and fully associative mapping method is utilized to search through the whole range of memory, page table is not necessary in the system disclosed by the present disclosure, as illustrated in FIG. 10, a fully associative memory is managed just like a hardware version of an associative table or a map (which can be data structures in software programming). The memory can store a collection of a constant number of address/contents pairs, it can also include bookkeeping information. It in essence can be functionally equivalent to a page table in a virtual memory system.

In traditional system utilizing virtual memory system, a translation lookaside buffer (TLB) is usually incorporated in the architecture. A translation lookaside buffer is a memory cache that is used to reduce the time taken to access a user memory location.

It can be a part of the chip's memory-management unit. The TLB stores the recent translations of virtual memory to physical memory and can be called an address-translation cache. A TLB may reside between the CPU and the system cache, between the system cache and the main memory, or between the different levels of the multi-level cache. The majority of desktop, laptop, and server processors include one or more TLBs in the memory-management hardware, and it is nearly always present in any processor that utilizes paged or segmented virtual memory.

However, in the present disclosure, because both the cache and the main memory are unified and organized in a style consistent with a fully associative mapping method and page table is not necessary, as TLB is a cache of recently used mappings out of those stored in the whole operating system page table, a TLB then also becomes redundant and unnecessary.

In addition, in the present disclosure, since the cache and main memory is unified and fully associative mapping method is utilized to search through the whole range of memory, virtual-physical address translation is not required, the memory management unit (MMU) which main function is to conduct virtual address-physical address translation is optional.

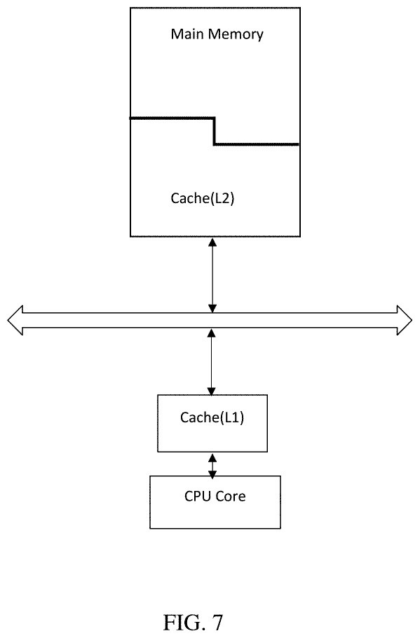

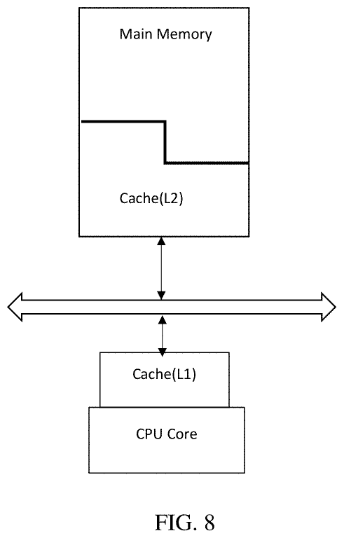

As illustrated in FIG. 7 and FIG. 8, it will then be understood that in some embodiments, multi-level cache can be provided, one of the cache can be a larger cache (lower level cache, for example, L2 cache) unified with the main memory, other caches can be smaller higher level caches and provided separated from the main memory, in an embodiment, the CPU chip can have an integrated Level 1 cache provided therein as shown in FIG. 8, while in other embodiments the smaller L1 cache can be provided separated from but near the CPU as illustrated in FIG. 7.

In these embodiments, the level 1 cache can be provided in a location being effectively between the unified cache and main memory and the CPU and there are no limitations to the number or level of caches provided. It will then be understood that reference to a unification of the cache and the main memory is tied to the treatment of the information stored therein and refers to a usage of the cache memory in a manner that represents an addition of the storage capacity of the cache memory to an overall or total storage because information stored in the cache is not a mere copy of information stored in main memory, but instead is utilized to store information which has been swapped between the cache and main memory.

For the convenience of description, the components of the apparatus may be divided into various modules or units according to functions which may be separately described. Certainly, when various embodiments of the present disclosure are carried out, the functions of these modules or units can be achieved utilizing one or more equivalent units of hardware or software as will be recognized by those having skill in the art.

The various device components, units, circuits, blocks, or portions may have modular configurations, or are composed of discrete components, but nonetheless can be referred to as “modules” in general. In other words, the “components,” “modules,” “circuits,” “portions,” or “units” referred to herein may or may not be in modular forms, and these phrases may be interchangeably used.

Persons skilled in the art should understand that the embodiments of the present disclosure can be provided for a method, system, or computer program product. Thus, various embodiments of the present disclosure can be in form of all-hardware embodiments, all-software embodiments, or a mix of hardware-software embodiments. Moreover, various embodiments of the present disclosure can be in form of a computer program product implemented on one or more computer-applicable memory media (including, but not limited to, disk memory, CD-ROM, optical disk, etc.) containing computer-applicable procedure codes therein.

The operations, steps including intermediate steps, and results from the computer system can be displayed on a display screen for a user. In some embodiments, the computer system can include the display screen, which can be a liquid-crystal display (LCD) or an organic light-emitting diode (OLED) display screen.

Various embodiments of the present disclosure are described with reference to the flow diagrams and/or block diagrams of the method, apparatus (system), and computer program product of the embodiments of the present disclosure. It should be understood that computer program instructions realize each flow and/or block in the flow diagrams and/or block diagrams as well as a combination of the flows and/or blocks in the flow diagrams and/or block diagrams. These computer program instructions can be provided to a processor of a general-purpose computer, a special-purpose computer, an embedded memory, or other programmable data processing apparatuses to generate a machine, such that the instructions executed by the processor of the computer or other programmable data processing apparatuses generate a device for performing functions specified in one or more flows of the flow diagrams and/or one or more blocks of the block diagrams.

These computer program instructions can also be stored in a computer-readable memory, such as a non-transitory computer-readable storage medium. The instructions can guide the computer or other programmable data processing apparatuses to operate in a specified manner, such that the instructions stored in the computer-readable memory generate an article of manufacture including an instruction device. The instruction device performs functions specified in one or more flows of the flow diagrams and/or one or more blocks of the block diagrams.

These computer program instructions may also be loaded on the computer or other programmable data processing apparatuses to execute a series of operations and steps on the computer or other programmable data processing apparatuses, such that the instructions executed on the computer or other programmable data processing apparatuses provide steps for performing functions specified ill one or more flows of the flow diagrams and/or one or more blocks of the block diagrams.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more modules of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium may be tangible.

The operations described in this disclosure can be implemented as operations performed by a data processing apparatus on data stored on one or more computer-readable storage devices or received from other sources.

Processors suitable for the execution of a computer program such as the instructions described above include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

The processor or processing circuit, such as the cache and memory management circuit; can be implemented by one or a plurality of application specific integrated circuits (ASICs), digital signal processors (DSPs), digital signal processing devices (DSPDs), programmable logic devices (PLDs), field programmable gate arrays (FPGA), controllers, microcontrollers, microprocessors, general processors, or other electronic components, so as to perform the above image capturing method.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

Although preferred embodiments of the present disclosure have been described, persons skilled in the art can alter and modify these embodiments once they know the fundamental inventive concept. Therefore, the attached claims should be construed to include the preferred embodiments and all the alternations and modifications that fall into the extent of the present disclosure.

The description is only used to help understanding some of the possible methods and concepts. Meanwhile, those of ordinary skill in the art can change the specific implementation manners and the application scope according to the concepts of the present disclosure. The contents of this specification therefore should not be construed as limiting the disclosure.

In the foregoing method embodiments, for the sake of simplified descriptions, the various steps are expressed as a series of action combinations. However, those of ordinary skill in the art will understand that the present disclosure is not limited by the particular sequence of steps as described herein.

According to some other embodiments of the present disclosure, some steps can be performed in other orders, or simultaneously, omitted, or added to other sequences, as appropriate.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

In addition, those of ordinary skill in the art will also understand that the embodiments described in the specification are just some of the embodiments, and the involved actions and portions are not all exclusively required, but will be recognized by those having skill in the art whether the functions of the various embodiments are required for a specific application thereof.

Various embodiments in this specification have been described in a progressive manner, where descriptions of some embodiments focus on the differences from other embodiments, and same or similar parts among the different embodiments are sometimes described together in only one embodiment.

It should also be noted that in the present disclosure, relational terms such as first and second, etc., are only used to distinguish one entity or operation from another entity or operation, and do not necessarily require or imply these entities having such an order or sequence. It does not necessarily require or imply that any such actual relationship or order exists between these entities or operations.

Moreover, the terms “include,” “including,” or any other variations thereof are intended to cover a non-exclusive inclusion such that a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, the commodity, or the device including the element.

In the descriptions, with respect to device(s), terminal(s), etc., in some occurrences singular forms are used, and in some other occurrences plural forms are used in the descriptions of various embodiments. It should be noted, however, that the single or plural forms are not limiting but rather are for illustrative purposes. Unless it is expressly stated that a single device, or terminal, etc. is employed, or it is expressly stated that a plurality of devices, or terminals, etc. are employed, the device(s), terminal(s), etc. can be singular, or plural.

Based on various embodiments of the present disclosure, the disclosed apparatuses, devices, and methods can be implemented in other manners. For example, the abovementioned terminals devices are only of illustrative purposes, and other types of terminals and devices can employ the methods disclosed herein.

Dividing the terminal or device into different “portions,” “regions” “or “components” merely reflect various logical functions according to some embodiments, and actual implementations can have other divisions of “portions,” “regions,” or “components” realizing similar functions as described above, or without divisions. For example, multiple portions, regions, or components can be combined or can be integrated into another system. In addition, some features can be omitted, and some steps in the methods can be skipped.

Those of ordinary skill in the art will appreciate that the portions, or components, etc. in the devices provided by various embodiments described above can be configured in the one or more devices described above. They can also be located in one or multiple devices that is (are) different from the example embodiments described above or illustrated in the accompanying drawings. For example, the circuits, portions, or components, etc. in various embodiments described above can be integrated into one module or divided into several sub-modules.

The numbering of the various embodiments described above are only for the purpose of illustration, and do not represent preference of embodiments.

Although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation to encompass such modifications and equivalent structures.

1. A computer system, comprising:
a central processing unit (CPU);
one or more cache memory provided proximal to the CPU and operatively connected to the central processing unit;
a main memory having at least one cache memory integrated therewith; and
a plurality of sets of computer executable instructions stored in computer system, wherein at least one set of computer executable instructions contains instructions for the computer system to perform:
the CPU sending a data request and access a cache portion of the main memory;
conducting fully associative search on the main memory including the at least one cache memory as one range of physical memory;
in a case that matching data is found on the cache portion, returning the data to the CPU;
in a case matching data is found on the main memory other than the cache portion, swapping the matching data to the cache portion and then returning the data to the CPU;
in a case that matching data is not found in either the cache portion or the main memory other than the cache portion, triggering the computer system to handle a page fault;

2. The computer system of claim 1, wherein the cache memory portion of the unified cache and main memory system is located between the central processing unit and the main memory portion of the unified cache and main memory system.

3. The computer system of claim 1, wherein the cache memory portion of the unified cache and memory portion is provided integrally with the central processing unit or close to the central processing unit.

4. The computer system of claim 1, wherein multi-level cache is provided.

5. The computer system of claim 4, wherein, one or more than one higher level cache is provided between the CPU and the unified lower level cache and main memory system, the unified lower level cache and main memory system is connected to the higher-level cache and central processing unit through bus.

6. The computer system of claim 4, wherein, one or more than one higher level cache is provided integrally with the central processing unit, the unified lower level cache and main memory system is connected to the higher-level cache and the central processing unit through bus.

7. The computer system of claim 1, wherein a storage size of the cache memory is greater than 50% of a storage size of the main memory.

8. The computer system of claim 7, wherein, the cache memory is unified with the main memory.

9. The computer system of claim 1, wherein the one or more sets of computer instructions include instructions for the system to swap data between the cache portion and main memory portion of the unified cache and main memory system in coordination of hardware in the system, so that information can be organized in a manner the data in the cache portion and the main memory portion of the unified cache and memory system is unique.

10. The computer system of claim 1, wherein the one or more sets of computer instructions include instructions for the system to organize information on the cache and main memory in a manner consistent with fully associative methods in coordination with hardware in the system.

11. A memory management method, comprising:
providing a central processing unit;
providing one or more than one cache memory proximal the central processing unit being operatively connected to the central processing unit;
providing a main memory; wherein, at least one cache memory is unified with the main memory; and
providing a plurality of sets of computer executable instructions stored in computer system, wherein at least one set of computer executable instructions contains instructions for the system to perform the following tasks in coordination with the hardware components in the system:
CPU sends a data request and access the cache portion of the unified cache and memory system;
conducting fully associative search on the unified cache and main memory system as one range of physical memory;
if matching data is found on the cache portion, return the data to the CPU;
if matching data is found on the main memory portion, swapping the matching data to the cache portion and then return the data to the CPU;
if matching data is not found in either the cache portion or the main memory portion of the unified cache and main memory system, triggering the operating system to handle the page fault.

12. The method of claim 11, wherein the data is swapped between the main memory portion and the cache portion of the unified cache and main memory system in a manner the data in the unified cache and memory system is unique.

13. The method of claim 11, wherein the one or more sets of computer instructions include instructions for the system to organize information on the unified cache and main memory system in a manner consistent with fully associative methods in coordination with hardware in the system

14. The method of claim 11, wherein one or more sets of computer instructions include instructions for the system to evict data on a portion of the cache portion of the unified cache and memory system and write the data to the main memory portion of the unified cache and main memory system in coordination with the hardware of the system, so that space in the cache portion will be available for future caching.
